(19) United States
(12) Patent Application Publication
(10) Pub. No.: US 2011/0297366 A1
(43) Pub. Date: Dec. 8, 2011

(54) JUMPER

(76) Inventors: J. Kenneth Wittle, Williamsburg, VA (US); James Harrison, Duluth, MN (US)

(21) Appl. No.: 12/792,815

(22) Filed: Jun. 3, 2010

(51) Int. Cl. H01R 31/06

(52) U.S. Cl. 166/65.1

(57) ABSTRACT

A jumper for insuring electrical or fluid communication between the liner and the casing of an oil field downhole. The jumper has a first tubing adapted to be inserted in the liner, a second tubing adapted to be inserted in the casing and an anchor adapted to be rigidly mounted in the casing. The first and second tubings are composed of an electrically conductive material and are supported by the anchor with an insulated joint. Each of the first and second tubings has a plurality of centering devices, each consisting of a pair of rings surrounding the tubing and an array of bowed springs bridging between the rings and biased to bow outwardly from the tubing into engagement with the inner circumference liner or the casing, as the case may be. One of the two rings is electrically connected to the tubing, for example by welding, whereas the other ring is free to be displaced longitudinally of the tubing so that the outer diameter of the array of bowed springs may expand or contract, as needed. Each bowed spring in the array is provided with a series of electrical contacts which insure electrical conductivity between the welded ring and the surrounding liner or casing through the bowed spring.

### FIELD OF INVENTION

The present invention relates to apparatus for enhancing the production of oil from subterranean oil reservoirs with the aid of electric current and, in particular, apparatus for enhancing the performance of the method described in U.S. Pat. No. 7,325,604, issued Feb. 5, 2008, the entire contents of which are incorporated herein by reference.

### BACKGROUND OF THE INVENTION

As set forth in more detail in U.S. Pat. No. 7,325,604, the oil bearing formation is tapped by drilling a downhole into the oil-bearing formation and providing a downhole liner to form an open conduit for the removal of oil. The liner is foraminous in order to permit the oil to enter the conduit throughout the length of the liner. It has been found that the production of oil is enhanced by connecting a negative electrode to the liner and introducing a second electrode in proximity to the formation. A voltage difference is established between the first and second electrodes to create an electric field across the formation. As shown in the patent, the downhole is drilled and the liner is installed and is connected to a casing which is anchored at the surface above the formation. At its lower end, the casing is connected to the proximal end of the liner and is operatively connected to the bore of the liner. The casing mounts a pump for the extraction of the oil produced by the well. The casing and the liners form a series of interconnected conduit sections which have joints along their lengths between the proximal distal ends of the drilling hole. It has been found that the joints between the conduit sections sometimes separate or deteriorate to a point where there is a substantial loss of voltage between adjacent conduit sections, and a possibility of leakage between the sections of the conduit sections and the surrounding underground formation.

### SUMMARY OF THE INVENTION

The present invention provides a electrical jumper for bridging the joints between the adjoining conduit sections to insure electrical conductivity between the conduit sections, reducing the loss of voltage which may occur when the joints deteriorate.

More specifically, the present invention provides a jumper composed of interconnected tubings adapted to be centered in the adjoined conduit sections on either side of the joint.

The tubings have a central bore which permits the flow of oil from the downhole into the casing where it is withdrawn by the conventional pump which is mounted at the bottom of the casing. The oil is pumped to the surface by the pump through piping.

In accordance with the invention, centering devices are provided about the outer perimeter of the tubings to center the same within the bores of the conduit sections, the centering devices including means to establish an electrical conductivity between the liner and the tubing.

In a preferred embodiment of the invention, the centering device includes a pair of rings encircling the tubing. The rings are connected by an array of bowed springs spaced circumferentially about the rings. Each bowed spring bows outwardly between the rings to resiliently bear against the interior bore of the conduit section in which it is mounted. Each ring encircles the outer circumference of the tubing, one of the rings being anchored to the tubing and the other of the rings being free to be displaced longitudinally of the tubing to allow radial expansion and contraction of the bowed springs.

The invention may also insure enhanced electrical conductivity by providing electrical contacts on the bowed springs where they bear against the internal bore of the associated conduit section to enhance the electrical conductivity between the bowed spring and the ring which is electrically connected to the tubing, for example by welding.

The jumper may be modified to reduce oil leakage through the joint between the interiors of the conduit sections and the surrounding underground formation.

### BRIEF DESCRIPTION OF THE DRAWINGS

The invention will be described in greater detail with reference to the accompanying drawings in which:

FIG. 1 is a side elevation of an electrical jumper embodying the present invention with an upper quadrant of the jumper broken away;

FIG. 2 is a diagrammatic view of an oil well having an upper casing and a lower liner vertically aligned, with a jumper according to FIG. 1 mounted therein to establish electrical contact therebetween;

FIG. 3 is a fragmentary view of an oil well having a horizontal liner inserted into the horizontal end of a casing with a jumper having portions respectively inserted into the casing and the liner to establish electrical contact therebetween.

FIG. 4 is a fragmentary view of an oil well having a horizontal liner adjacent the horizontal end of a casing with a further modified jumper having portions respectively inserted into the casing and the liner to establish electrical contact therebetween and to reduce leakage through the joint between a casing and a liner; and

FIG. 5 is an enlarged sectional view of a tubing portion of the jumper which is mounted inside the casing showing its connection to the adjoining tubing portion of the jumper which is mounted inside the liner.

### DESCRIPTION OF THE PREFERRED EMBODIMENTS

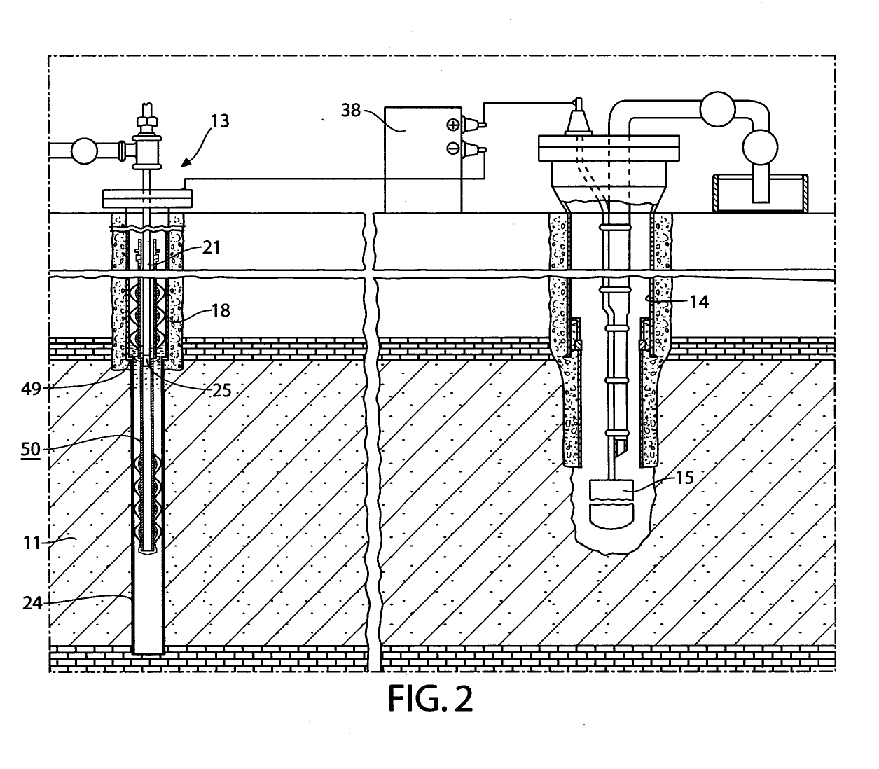

Referring to FIG. 2, the drawing illustrates an oil producing well 13 of the type shown in U.S. Pat. No. 7,325,604. The well 13 has a bore hole penetrating the oil-bearing formation 11 having a foraminous liner 24 which is connected to a casing 18 extending from the surface to the top of the formation 11 by a connecting joint at 49. The liner and casing are metallic and are connected to the negative terminal of an electric voltage source 38. A second bore hole 14 penetrates the oil formation 11 and encloses an electrode 15 which is connected to the positive terminal of the voltage source 38. As set forth in the above patent, the voltage source supplies an electric signal which has been found to enhance the production of oil from the formation 11. A pump 25 is mounted in the casing and has piping 21 for discharging the oil accumulating at the bottom of the casing 18. The casing and the liner constitute conduit sections which are effective to conduct oil from the oil-bearing formation into the casing where it is extracted by the pump 25.

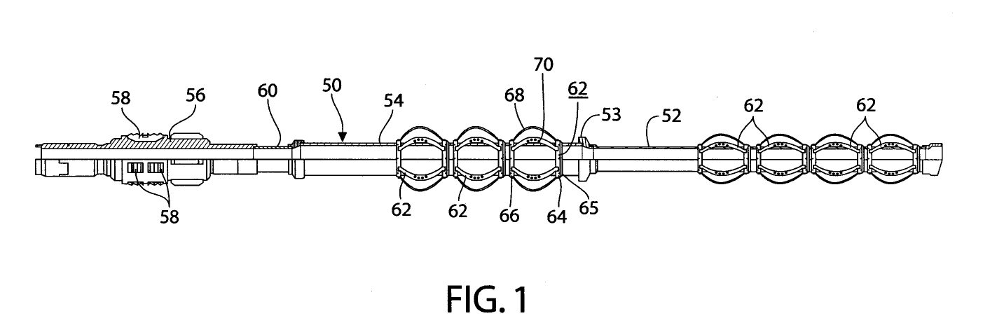

In accordance with the invention, it has been found that the electrical continuity between the liner and the casing may be impaired, and it is desirable to provide a jumper to assure electrical continuity between the conduit sections. To this end, as shown in FIG. 1, a jumper 50 has a first tubing 52 which is hollow and is designed to fit within the distal conduit section, in the present instance the liner 24 and a second tubing 54 designed to fit within the proximal conduit section provided by the casing 18. The tubings 52 and 54 are interconnected by a joint 53 and are adapted to be anchored into the well by an anchor 56 which has a series of jaws 58 which are operable to be displaced radially outward to firmly anchor the jumper within the bore hole. Preferably, the anchor has at least three jaws equally spaced about its perimeter so as to firmly anchor the jumper into the casing. The anchor 56 is connected to the tubings 52 and 54 by a fiberglass pup joint 60 of fiberglass or other insulating material which electrically isolates the anchor 56 from the interconnected tubings 52 and 54. In the present instance, the tubings are centered within their respective conduit sections by centering devices 60 to provide a narrow annular space surrounding each tubing.

Each centering device comprises a pair of rings 64 and 66 encircling the tubing. One of the rings 64 is electrically connected to the tubing 54, for example by a weld joint 65, whereas the opposite ring 64 is slidable on the underlying tubing. The two rings 64 and 66 are interconnected by leaf springs 68 which span between the rings and are bowed outwardly to engage the interior wall of the surrounding conduit section. The bowed leaf springs are arranged in a circular array about the entire circumference of the connector 62 and are biased outwardly into firm engagement with the interior wall of the surrounding conduit section. The displaceable ring 66 may be displaced longitudinally of the tubing to increase or decrease the projection of the outer perimeter of the array of bowed springs 68, as required by their engagement with the interior surface of the conduit section. To ensure electrical contact between the springs and the tubing, the medial portions of the leaf spring 68 are provided with electrical contacts 70 which assure electrical contact between the springs and the tubing. The electrical path between the contacts 70 and the connected ring 64 is through the spring itself, but if desired, an additional electrical path may be provided to assure electrical conductivity from the conduit section through the contact to the ring 64 and the underling tubing. It has been found desirable to design the jumper so that the bores of the tubings are between 40-55% of the bore of the associated conduit section, leaving room for the centering devices in the annular space surrounding the liners.

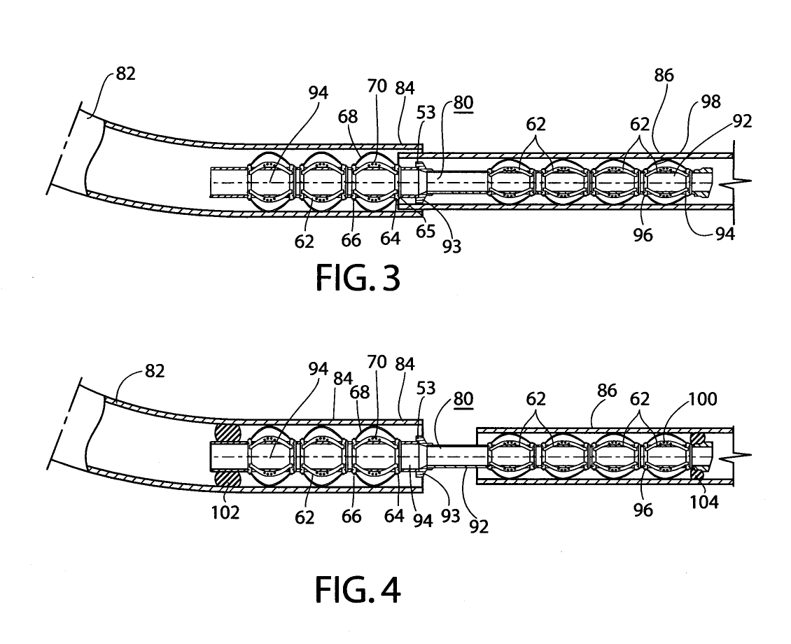

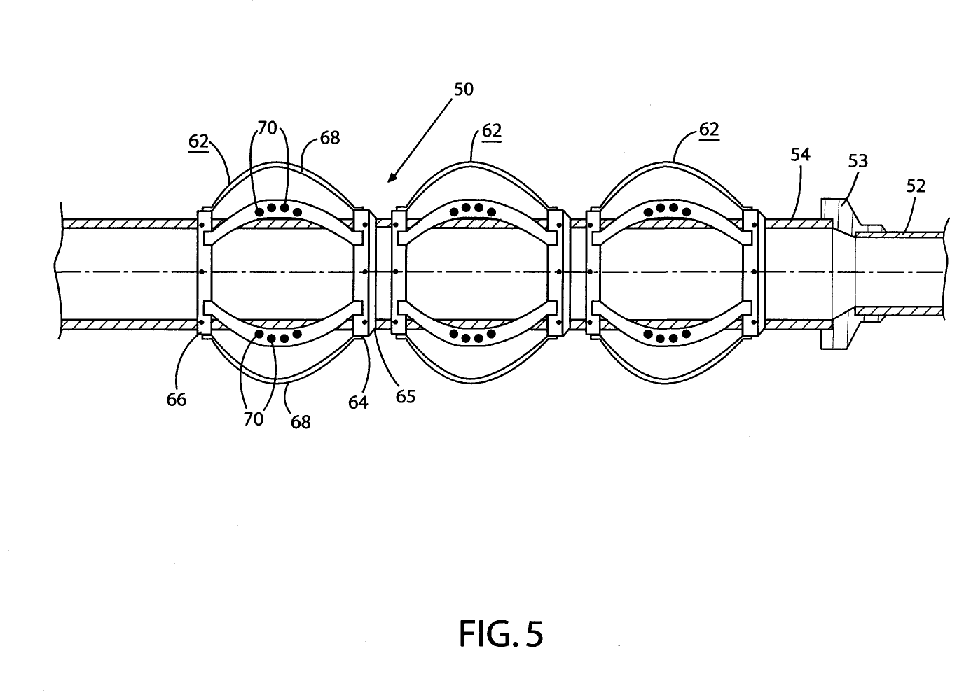

FIGS. 3 and 4 show modified jumpers 80 inserted between a well casing and horizontal liners of the downhole. In the present instance, the well casing 82 terminates in a horizontal extension 84 which is adapted to interconnect with the proximal end of a liner 86 of the downhole. As shown in FIG. 3, the liner 86 telescopically engages the open end of the extension 84, whereas in FIG. 4, the liner 86 is separated from the extension 84. In each case, the jumper 80 is provided to provide electrical continuity between the casing 82 and the liner 86.

With reference to the embodiment shown in FIG. 4, when the jumper is used to bridge a gap in the series of interconnected conduit sections, it may be desirable to insert an annular plug 102 between the extension 84 and the tubing 94 to close off the annular space between these components. Similarly, the space between the liner 86 and the tubing 92 may be plugged by an annular plug 104 to reduce leakage which would otherwise occur as a result of the gap. In this case, the jumper 82 not only provides electrical conductivity between the separated conduit sections, but also prevents leakage between the interiors of the conduit sections and the underground formation surrounding the gap. The plugs are annular rings of nitrile or other elastomeric material which is resistant to the fluids carried by the conduit sections.

The overall length of the jumper 80 is shorter than the jumper 60 so that it will pass through the curvature between the extension 84 and the upper end of the casing at the surface. The casing follows an arcuate path from the surface to the extension 84 and the length of the jumper is tailored to pass along the arcuate path without jamming. In other respects, the jumper 80 is similar to the jumper 60 having distal and proximal tubings 92 and 94 interconnected by a joint 93. The tubings 92 and 94 have centering devices comprising fixed rings 94 and slidable rings 96 which are interconnected by bowed springs 98 disposed in a circular array between the rings 94 and 96. The bowed springs 98 are provided with electrical contacts 100 similar to the contacts 70 described in connection with FIG. 1. The contacts are designed to provide electrical continuity between the liners 84 and 86 and the fixed rings 94 of the centering devices.

Preferably, each embodiment of the invention is designed to complement the conduit sections into which the jumper is installed. Preferably, each tubing has a bore which is between 40-55% of the bore of the associated conduit section to provide an annular space surrounding the tubings. In the embodiment of FIG. 3, the joint between the proximal and distal tubings has an outer perimeter smaller than the bore of the conduit section surrounding the distal tubing so as to allow limited flow between the annular spaces surrounding the distal and proximal tubings.

While particular embodiments of the present invention have been herein described, it is not intended to limit the invention to such disclosures but changes and modifications may be made therein and thereto within the scope of the following claims.

1. An electrical jumper for an oil field downhole having a plurality of interconnected conduit sections including a hollow casing and at least one hollow liner, the bore of said at least one liner being longitudinally aligned with the bore of said casing, said jumper adapted to insure electric conductivity between said interconnected conduit sections and comprising:
a first tubing adapted to be inserted in a first conduit section,
a second tubing adapted to be inserted in a second conduit section,
said first and second tubings being composed of an electrically conductive material,
a plurality of centering devices mounted on each of said first and second tubings,
each centering device consisting of a pair of rings surrounding the tubing and an array of bowed springs bridging between the rings and biased to bow outwardly from the tubing into contact with the bore of the associated conduit section,
at least the first of said two rings being electrically connected to the tubing, and
each bowed spring of said array having electrical contacts connected to said electrically connected ring,
the second of said two rings being adapted to be displaced longitudinally of the tubing relative to said connected ring, so that the outer diameter of the array of bowed springs may expand or contract to maintain said electrical contacts in operative engagement with the bore of the associated conduit section.

2. An electrical jumper for an oil field downhole according to claim 1, wherein each of said arrays of bowed springs comprises at least three springs spaced circumferentially about said pair of rings.

3. An electrical jumper for an oil field downhole according to claim 2, wherein said bowed springs are equally spaced about said pair of rings.

4. An electrical jumper for an oil field downhole according to claim 1 wherein said bowed springs are electrically conductive to constitute the electrical connection between said electrical contacts and said electrically connected ring.

5. An electrical jumper for an oil field downhole according to claim 1 including an anchor adapted to be rigidly mounted in said casing and supporting said tubings in alignment with the longitudinal centerlines of the bores of said casing and said liner.

6. An electrical jumper for an oil field downhole according to claim 5,
said anchor having a body and an insulating connector connecting said body to said second tubing, and
at least three jaws disposed circumferentially about said body and adapted to be displaced radially outward to firmly engage the interior of said casing and rigidly mount said body within said casing.

7. An electrical jumper for an oil field downhole according to claim 1 wherein said conduit sections are longitudinally aligned at a joint,
said jumper adapted to be mounted within said tubular conduit sections to bridge said joint with the first tubing within one conduit section and the second tubing within the adjoining conduit section.

8. An electrical jumper for an oil field downhole according to claim 7 wherein said tubings have a bore which is between 40 and 55% of the bore of the associated conduit section and are interconnected by a fitting, said fitting and said tubings providing an annular space surrounding said tubings and said fitting, said connector joint and said fitting allowing flow between the annular spaces surrounding the tubings of the interconnected conduit sections.

9. A jumper for a downhole for extracting fluids from an underground formation, said downhole having at least two intercommunicating plurality of conduit sections including a hollow casing and at least one hollow liner, said jumper having two liners, one line adapted to be inserted into the bore of said at least one of said conduit section longitudinally aligned with the bore of an adjoining intercommunicating conduit sections, said jumper adapted to insure fluid communication between said conduit sections and comprising
a first tubing adapted to be inserted in a first conduit section,
a second tubing adapted to be inserted in a second conduit section,
centering devices mounted on each of said first and second tubings,
each centering device consisting of a pair of rings surrounding the tubing and an array of bowed springs bridging between the rings and biased to bow outwardly from the tubing into contact with the bore of the associated conduit section,
the first of said two rings being connected to the tubing, and
the second of said two rings being adapted to be displaced longitudinally of the tubing relative to said connected ring, so that the outer diameter of the array of bow springs may expand or contract to maintain said bowed springs in operative engagement with the bore of the associated conduit section.

10. A jumper for a downhole according to claim 9 wherein said tubings have a bore which is between 40 and 55% of the bore of the associated conduit section and are interconnected by a fitting, said fitting and said tubings providing an annular space surrounding said tubings and said fitting, said connector joint and said fitting allowing flow between the annular spaces surrounding the tubings within the intercommunicating conduit sections.

11. A jumper for a downhole according to claim 9 wherein said tubings have a bore which is between 40 and 55% of the bore of the associated conduit section and are interconnected by a fitting, said fitting and said tubings providing an annular space surrounding said tubings and said fitting, and a pair of annular plugs composed of an elastomeric material resistant to the fluids in said downhole, one of said plugs surrounding one of said tubing and engaging the bore of the associated conduit section to block longitudinal flow in said annular space, and the other of said plugs surrounding the other of said tubings and engaging the bore of the other of said intercommunicating conduit sections to block longitudinal flow in said annular space, said plugs preventing escape of fluid into said annular space surrounding said fitting.
